(19) United States
(12) Patent Application Publication
(10) Pub. No.: US 2026/0173242 A1
(43) Pub. Date: Jun. 18, 2026

(54) METHOD FOR CHANGING AT LEAST ONE LIGHTING STATE BY VOICE COMMAND, A COMPUTER SYSTEM CONFIGURED TO EXECUTE THE METHOD AND A COMPUTER PROGRAM PRODUCT COMPRISING SECTIONS OF SOFTWARE CODE

(71) Applicant: MA Lighting Technology GmbH, Waldbütttelbrunn (DE)

(72) Inventors: Alexander Schneider, Waldbrunn (DE); Michael Kohl, Würzburg (DE); Tobias Wursthorn, Bremen (DE)

(21) Appl. No.: 19/397,481

(22) Filed: Nov. 21, 2025

(30) Foreign Application Priority Data
Dec. 4, 2024 (DE) 102024136184.0

(51) Int. Cl. H05B 47/175; G06F 3/16; G10L 15/22; H05B 47/14

(52) U.S. Cl. CPC H05B 47/197; G06F 3/167; G10L 15/22; H05B 47/14; G10L 2015/223

(57) ABSTRACT

A method for changing at least one lighting state by voice command comprises receiving and inputting the voice command into a language model, interpreting and breaking down the voice command into at least one subtask, obtaining at least one lighting feature of at least one lighting object and at least one setting option of the lighting feature, determining at least one lighting object and at least one lighting feature of the determined lighting object by inference with a trained machine learning model involving input of the lighting feature, the setting option and the subtask, creating a sequence sheet by inference with the trained machine learning model involving input of the determined lighting object, the determined lighting feature and/or the setting option and changing the lighting state in accordance with the sequence sheet. A computer system is configured to execute the method, with a processor executing a computer program product comprising sections of software code.

### FIELD OF THE INVENTION

The invention relates to a method for changing at least one lighting state by voice command, a computer system configured to execute the method and a computer program product comprising sections of software code by means of which the method for changing at least one lighting state by voice command is executed.

### BACKGROUND

In the prior art it is known to use light shows to accompany performances, such as concerts or plays, but also purely auditory performances, such as music in nightclubs, and/or to increase the visibility of the presentation. As light technology advances, the operating staff is provided with an ever-increasing number of options. Therefore, it has become necessary for lighting systems to be controlled automatically by using complex control engineering, both in terms of the emitted light and in terms of movement. Different control protocols for controlling the individual lighting means, which must be programmed by partially deviating commands, have become established. The light shows are generally pre-programmed in parts or fully and are played during the performance, an adjustment being possible to a limited extent.

As a consequence of the widespread use of the aforementioned programming of the light show, it can only be performed by trained staff due to the complexity. The staff must be proficient in the corresponding programming language, part of which has been specially developed by the manufacturer of the control engineering and is therefore not uniform in the industry, and they must be familiar with the arrangement and features of the available lighting equipment and the location so that they will be able to create an appealing and coordinated light show.

Few assistance systems that make suggestions to the user based on presettings made by the user, a light show library or previous light shows are known in the prior art. Furthermore, a method is known from U.S. Pat. No. 11,687,760B2 , which, following input of initial commands, suggests to the user at least one further command with the aid of a multiplicity of previously created light shows, the further command, statistically speaking, frequently following the commands entered so far.

Nevertheless, creating, changing and adjusting light shows remains a complex process that can only be carried out after adequate training. There is a tendency for applications to become more complex due to the advancing technical possibilities.

### SUMMARY OF THE INVENTION

Therefore, there is a great need for a method that makes it possible to change a lighting state of lighting objects for a light show in a simple and intuitive way and that can be used for all conceivable use cases. Further attention is therefore being paid to the method being usable with all devices known in the prior art and being executable at a reasonable price. In this way, the creation and/or adjustment of light shows can be largely supported and/or automated. The invention has therefore set itself the task of providing a method, a computer system and a computer program product in order to overcome the above-mentioned difficulties.

This task is achieved in a surprisingly simple but effective way by a method according to the teaching of independent claim 1, a computer system according to the teaching of main claim 14 and a computer program product according to the teaching of main claim 15.

According to the invention, a method for changing at least one lighting state by voice command is proposed, the method comprising the following steps:
a. receiving a voice command and inputting a voice command in a language model in the first step;
b. interpreting and breaking down the voice command into at least one subtask in the second step;
c. obtaining at least one lighting feature of at least one lighting object and at least one setting option of the at least one lighting state and determining at least one lighting object and at least one lighting feature of the at least one determined lighting object by inference with the trained machine learning model involving input of the at least one lighting feature, the at least one setting option and the at least one subtask in the third step;
d. creating a sequence sheet by inference with the trained machine learning model involving input of the at least one determined lighting object, the at least one determined lighting feature and/or the at least one setting option in the fourth step; and
e. changing the at least one lighting state according to the sequence sheet in the fifth step.

The invention is based on the fundamental idea that, as a result of the ever advancing development of language models, they can be used with the aim of interpreting a command from a user expressed in natural language and ultimately converting said command into a change to one lighting object or multiple lighting objects for a light show and/or for creating a light show. To do this, it is necessary to first divide the voice command into subtasks and, by using a specially trained machine learning model, to convert these into corresponding control codes and/or other possible control options and/or visualizations for the user.

In the first step a., a voice command is received and input into a language model. This enables performing subsequent step b. The voice command is preferably received through a corresponding interface by input from a user applying the method in real time. Suitable interfaces are mentioned elsewhere. Preferably, the language model used is specifically trained for the application of the method according to the invention. Even more preferably, the language model is a large language model (LLM), in particular a generative pre-trained transformer (GPT).

In the next, here second, step b., the voice command is interpreted by the language model and broken down into at least one subtask. In other words, the language model breaks down the voice command into individual aspects that must be worked through to achieve the desired change. Preferably, the voice command is broken down into at least 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90 or 100 subtasks. In particular, the subtasks can relate to changing different lighting features of the lighting state of a lighting object, individual lighting features of the lighting state of different lighting objects, different lighting features of different lighting objects and/or other aspects outside the lighting object, in particular aspects that directly or indirectly relate to the at least one lighting object. Particularly preferably, the at least one subtask is converted into a predefined syntax. This is easily possible due to the limited number of options for change and leads to better and/or more precise results.

In the next, here third, step c., at least one lighting feature of at least one lighting object and at least one setting option of the at least one lighting object are obtained, the at least one lighting feature, the at least one setting option and the at least one subtask being input into a trained machine learning model, the trained machine learning model determining at least one lighting object and at least one lighting feature of the previously determined lighting object by inference. As a result of the determination, the at least one lighting object becomes the at least one determined lighting object and the at least one determined lighting feature becomes the at least one determined lighting feature. In most cases, it is necessary and/or desired to change individual lighting features and/or individual lighting objects in order to bring about the change desired in the voice command. Obtaining the lighting feature can relate to the type of lighting feature, the value of the lighting feature and/or the value range of the lighting feature. In other words, it is conceivable that obtaining the lighting feature relates to collecting knowledge about the presence of a determined lighting feature at the at least one lighting object, the specific setting of the lighting feature and/or the technically possible settings. It is preferable if the technically possible settings are taken into account in such a way that a determination of the at least one lighting object and/or the at least one lighting feature that cannot implement the desired change due to its setting options is prevented during the determination. The at least one lighting feature and/or the at least one setting option is preferably obtained by retrieval in a database and/or of stored data, by querying the settings of the at least one lighting feature, by evaluating previous control commands and/or by querying at least one status sensor. The determination is made possible by training the trained machine learning model using sets of training data before executing the method. The training is preferably supervised learning, unsupervised learning or reinforcement learning. In particular, the determination leads to the selection and/or setting of a value to be assumed of these lighting features and/or lighting objects.

Preferably, at least 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 100, 150, 200, 250, 300, 350, 400, 450, 500, 550, 600, 650, 700, 750, 800, 850, 900, 950, 1,000, 1,500, 2,000, 2,500, 3,000, 3,500, 4,000, 4,500, 5,000, 5,500, 6,000, 6,500, 7,000, 7,500, 8,000, 8,500, 9,000, 9,500, 10,000, 15,000, 20,000, 25,000, 30,000, 35,000, 40,000, 45,000, 50,000, 55,000, 60,000, 65,000, 70,000, 75,000, 80,000, 85,000, 90,000, 95,000, 100,000, 150,000, 200,000, 250,000, 300,000, 350,000, 400,000, 450,000, 500,000, 550,000, 600,000, 650,000, 700,000, 750,000, 800,000, 850,000, 900,000, 950,000, 1,000,000, 1,500,000, 2,000,000, 2,500,000, 3,000,000, 3,500,000, 4,000,000, 4,500,000, 5,000,000, 5,500,000, 6,000,000, 6,500,000, 7,000,000, 7,500,000, 8,000,000, 8,500,000, 9,000,000, 9,500,000, 10,000,000, 15,000,000, 20,000,000, 25,000,000, 30,000,000, 35,000,000, 40,000,000, 45,000,000, 50,000,000, 55,000,000, 60,000,000, 65,000,000, 70,000,000, 75,000,000, 80,000,000, 85,000,000, 90,000,000, 95,000,000, 100,000,000, 150,000,000, 200,000,000, 250,000,000, 300,000,000, 350,000,000, 400,000,000, 450,000,000, 500,000,000, 550,000,000, 600,000,000, 650,000,000, 700,000,000, 750,000,000, 800,000,000, 850,000,000, 900,000,000, 950,000,000 or 1,000,000,000 different or identical lighting features are obtained. Even more preferably, the lighting state of at least one lighting object is obtained. Further preferably, at least one lighting feature of at least 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 100, 150, 200, 250, 300, 350, 400, 450, 500, 550, 600, 650, 700, 750, 800, 850, 900, 950, 1,000, 1,500, 2,000, 2,500, 3,000, 3,500, 4,000, 4,500, 5,000, 5,500, 6,000, 6,500, 7,000, 7,500, 8,000, 8,500, 9,000, 9,500, 10,000, 15,000, 20,000, 25,000, 30,000, 35,000, 40,000, 45,000, 50,000, 55,000, 60,000, 65,000, 70,000, 75,000, 80,000, 85,000, 90,000, 95,000, 100,000, 150,000, 200,000, 250,000, 300,000, 350,000, 400,000, 450,000, 500,000, 550,000, 600,000, 650,000, 700,000, 750,000, 800,000, 850,000, 900,000, 950,000, 1,000,000, 1,500,000, 2,000,000, 2,500,000, 3,000,000, 3,500,000, 4,000,000, 4,500,000, 5,000,000, 5,500,000, 6,000,000, 6,500,000, 7,000,000, 7,500,000, 8,000,000, 8,500,000, 9,000,000, 9,500,000, 10,000,000, 15,000,000, 20,000,000, 25,000,000, 30,000,000, 35,000,000, 40,000,000, 45,000,000, 50,000,000, 55,000,000, 60,000,000, 65,000,000, 70,000,000, 75,000,000, 80,000,000, 85,000,000, 90,000,000, 95,000,000, 100,000,000, 150,000,000, 200,000,000, 250,000,000, 300,000,000, 350,000,000, 400,000,000, 450,000,000, 500,000,000, 550,000,000, 600,000,000, 650,000,000, 700,000,000, 750,000,000, 800,000,000, 850,000,000, 900,000,000, 950,000,000 or 1,000,000,000 different or identical lighting objects, which may be identical and/or different lighting features, is obtained. Most preferably, the lighting state of all lighting objects is obtained. This enables particularly precise and comprehensive adjustment, but the amount of data obtained is very large, depending on the setup. Preferably, at least 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 100, 150, 200, 250, 300, 350, 400, 450, 500, 550, 600, 650, 700, 750, 800, 850, 900, 950, 1,000, 1,500, 2,000, 2,500, 3,000, 3,500, 4,000, 4,500, 5,000, 5,500, 6,000, 6,500, 7,000, 7,500, 8,000, 8,500, 9,000, 9,500, 10,000, 15,000, 20,000, 25,000, 30,000, 35,000, 40,000, 45,000, 50,000, 55,000, 60,000, 65,000, 70,000, 75,000, 80,000, 85,000, 90,000, 95,000, 100,000, 150,000, 200,000, 250,000, 300,000, 350,000, 400,000, 450,000, 500,000, 550,000, 600,000, 650,000, 700,000, 750,000, 800,000, 850,000, 900,000, 950,000, 1,000,000, 1,500,000, 2,000,000, 2,500,000, 3,000,000, 3,500,000, 4,000,000, 4,500,000, 5,000,000, 5,500,000, 6,000,000, 6,500,000, 7,000,000, 7,500,000, 8,000,000, 8,500,000, 9,000,000, 9,500,000, 10,000,000, 15,000,000, 20,000,000, 25,000,000, 30,000,000, 35,000,000, 40,000,000, 45,000,000, 50,000,000, 55,000,000, 60,000,000, 65,000,000, 70,000,000, 75,000,000, 80,000,000, 85,000,000, 90,000,000, 95,000,000, 100,000,000, 150,000,000, 200,000,000, 250,000,000, 300,000,000, 350,000,000, 400,000,000, 450,000,000, 500,000,000, 550,000,000, 600,000,000, 650,000,000, 700,000,000, 750,000,000, 800,000,000, 850,000,000, 900,000,000, 950,000,000 or 1,000,000,000 setting options are obtained.

Further preferably, at least one setting option of at least 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 100, 150, 200, 250, 300, 350, 400, 450, 500, 550, 600, 650, 700, 750, 800, 850, 900, 950, 1,000, 1,500, 2,000, 2,500, 3,000, 3,500, 4,000, 4,500, 5,000, 5,500, 6,000, 6,500, 7,000, 7,500, 8,000, 8,500, 9,000, 9,500, 10,000, 15,000, 20,000, 25,000, 30,000, 35,000, 40,000, 45,000, 50,000, 55,000, 60,000, 65,000, 70,000, 75,000, 80,000, 85,000, 90,000, 95,000, 100,000, 150,000, 200,000, 250,000, 300,000, 350,000, 400,000, 450,000, 500,000, 550,000, 600,000, 650,000, 700,000, 750,000, 800,000, 850,000, 900,000, 950,000, 1,000,000, 1,500,000, 2,000,000, 2,500,000, 3,000,000, 3,500,000, 4,000,000, 4,500,000, 5,000,000, 5,500,000, 6,000,000, 6,500,000, 7,000,000, 7,500,000, 8,000,000, 8,500,000, 9,000,000, 9,500,000, 10,000,000, 15,000,000, 20,000,000, 25,000,000, 30,000,000, 35,000,000, 40,000,000, 45,000,000, 50,000,000, 55,000,000, 60,000,000, 65,000,000, 70,000,000, 75,000,000, 80,000,000, 85,000,000, 90,000,000, 95,000,000, 100,000,000, 150,000,000, 200,000,000, 250,000,000, 300,000,000, 350,000,000, 400,000,000, 450,000,000, 500,000,000, 550,000,000, 600,000,000, 650,000,000, 700,000,000, 750,000,000, 800,000,000, 850,000,000, 900,000,000, 950,000,000 or 1,000,000,000 different or identical lighting objects, which may be identical and/or different setting options, is obtained. Most preferably, all setting options of all lighting objects are obtained. This enables particularly precise and comprehensive adjustment, but the amount of data obtained is very large, depending on the setup. Preferably, a number of lighting objects and/or lighting features that is below the total number of available lighting objects is determined when the determination is carried out. Further preferably, at least 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 100, 150, 200, 250, 300, 350, 400, 450, 500, 550, 600, 650, 700, 750, 800, 850, 900, 950, 1,000, 1,500, 2,000, 2,500, 3,000, 3,500, 4,000, 4,500, 5,000, 5,500, 6,000, 6,500, 7,000, 7,500, 8,000, 8,500, 9,000, 9,500, 10,000, 15,000, 20,000, 25,000, 30,000, 35,000, 40,000, 45,000, 50,000, 55,000, 60,000, 65,000, 70,000, 75,000, 80,000, 85,000, 90,000, 95,000, 100,000, 150,000, 200,000, 250,000, 300,000, 350,000, 400,000, 450,000, 500,000, 550,000, 600,000, 650,000, 700,000, 750,000, 800,000, 850,000, 900,000, 950,000, 1,000,000, 1,500,000, 2,000,000, 2,500,000, 3,000,000, 3,500,000, 4,000,000, 4,500,000, 5,000,000, 5,500,000, 6,000,000, 6,500,000, 7,000,000, 7,500,000, 8,000,000, 8,500,000, 9,000,000, 9,500,000, 10,000,000, 15,000,000, 20,000,000, 25,000,000, 30,000,000, 35,000,000, 40,000,000, 45,000,000, 50,000,000, 55,000,000, 60,000,000, 65,000,000, 70,000,000, 75,000,000, 80,000,000, 85,000,000, 90,000,000, 95,000,000, 100,000,000, 150,000,000, 200,000,000, 250,000,000, 300,000,000, 350,000,000, 400,000,000, 450,000,000, 500,000,000, 550,000,000, 600,000,000, 650,000,000, 700,000,000, 750,000,000, 800,000,000, 850,000,000, 900,000,000, 950,000,000 or 1,000,000,000 lighting objects and/or lighting features are determined. Even more preferably, at least one lighting feature and/or at least one setting option of the at least one determined lighting object, which is supposed to undergo a change or bring about the change, is determined.

Most preferably, at least 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 100, 150, 200, 250, 300, 350, 400, 450, 500, 550, 600, 650, 700, 750, 800, 850, 900, 950, 1,000, 1,500, 2,000, 2,500, 3,000, 3,500, 4,000, 4,500, 5,000, 5,500, 6,000, 6,500, 7,000, 7,500, 8,000, 8,500, 9,000, 9,500 or 10,000 setting options of at least one determined lighting object are determined.

In the next, here fourth, step d., a sequence sheet is created by inputting the at least one determined lighting object, the at least one determined lighting feature and/or the at least one setting option into the trained machine learning model by inference. The creation of the sequence sheet by inference is made possible by training the trained machine learning model with sets of training data before the method is executed. The training is preferably supervised learning, unsupervised learning or reinforcement learning. The sequence sheet implements all subtasks according to the user's specifications. Further preferably, the trained machine learning model is updated during and/or after execution of the method according to the invention, by the user performing an evaluation of the sequence sheet that has been created or evaluating intermediate information fed back to the user during the execution of the method and this evaluation being fed to the machine learning model as a new set of training data. This allows continuous improvement and individualization of the trained machine learning model by the user. Further preferably, at least one setting option for setting the at least one determined lighting object and/or the at least one determined lighting feature is determined in step c. and/or in step d.

The trained machine learning model is preferably divided into two parts, with the first part being used in step c. and the second part being used in step d. This makes it possible to easily read out interim results, in particular the result of the determination of the at least one lighting object and/or the at least one lighting feature, which facilitates the correction of errors by adjustment. Further, it is conceivable that there are two independent trained machine learning models, the trained machine learning model in step c. being a first trained machine learning model and the trained machine learning model in step d. being a second trained machine learning model. Even more preferably, the trained machine learning model consists of one piece, which enables step c. and step d. to be performed partially or fully in parallel and/or to be repeated at least once. This leads to better results with a faster execution time. Particularly preferably, the trained machine learning model is an artificial neural network, in particular a recurrent neural network (RNN), a feedforward neural network (FNN), a convolutional neural network (CNN), a transformer, a flow-based generative model, an evolving neural network, an encoder-decoder model, a variational autoencoder, an autoregressive model (ARMA Model), a restricted Boltzmann machine (RBM) and/or a diffusion model, a hidden Markov model (HMM) and/or a support vector machine (SVM). In addition, it is conceivable to use the methods of genetic programming, boosting, decision tree machine learning, kernel density estimation (KDE), expert systems (ES), a (naive) Bayes classifier, gradient boosting, linear discriminant analysis, the nearest neighbor classifier, a cluster analysis method, in particular the single linkage method, the complete linkage method, the Ward method, the K-Means algorithm, the fuzzy C-means algorithm, the expectation maximization algorithm (EM algorithm), DBSAN (density-based spatial clustering of applications with noise), the STING algorithm (statistical information grid-based clustering algorithm) and/or the CLIQUE algorithm (CLustering InQUEst algorithm) and/or a method of anomaly detection, in particular the local outlier factor (LOF), the isolation forest and/or the autoencoder and/or principal component analysis (PCA). Further, reinforcement learning methods, such as associative reinforcement learning, deep reinforcement learning, adversarial deep reinforcement learning, fuzzy reinforcement learning and/or safe reinforcement learning can be used. In particular, it is conceivable to also use methods for clustering data. Suitable measures for creating, using and/or training are known to the person skilled in the art. It is also conceivable that the training data is stored in a database, the database being continuously expanded by new training data during operation or when using the method according to the invention. Further, it is conceivable that the trained machine learning model is the language model from step b. Further models with machine learning capability as well as options for creating, using and/or training the models are known to the person skilled in the art.

Further, it is conceivable that an agent system checks and validates the result, namely the at least one subtask, the determination of the at least one lighting object and/or the at least one lighting feature of the at least one determined lighting object and/or the sequence sheet after performing steps a., b., c. and/or d. It is conceivable to repeat steps a., b., c. and/or d. partially or fully by modifying the input if the check turns out to be negative. In a preferred extension of the agent system, multiple agents with dedicated roles are used, such as, in particular, for checking the results, for analyzing error messages, for general monitoring and for dividing up the subtasks and/or for executing the commands themselves.

Preferably, the sequence sheet comprises at least one set of simulation data, at least one model, in particular a virtual 3D model, at least one cue, in particular a series of cues, at least one preset, at least one sequence, at least one stack, at least one video file, in particular a video recording and/or simulation, and/or at least one data packet, in particular comprising recipes, MAtricks, phasers, timecodes, macros, Lua plugins, filters, selections, effects, BitMaps and/or generators. Particularly preferably, the sequence sheet comprises a DMX data packet or an ArtNetdata packet. This concerns the most common protocols for controlling lighting technology. Particularly preferably, the data packet itself comprises at least one preset, at least one cue, at least one sequence and/or at least one stack. The set of simulation data preferably concerns a simulation of a stage with lighting objects arranged thereon, in particular lighting devices. Further preferably, the model also shows a stage with lighting objects, in particular lighting devices. Further preferably, the video file, in particular the video recording and/or the simulation, shows the sequence of a light show.

Subsequently, at least one lighting state is changed in accordance with the sequence sheet in the next, here fifth, step e. It is also conceivable that the sequence sheet is stored in a series of sequence sheets, in particular at the end of the series of sequence sheets, to create and store a light show. Further, it is conceivable that the sequence sheet replaces another sequence sheet in the series of sequence sheets. As a result, an existing light show is modified according to the user's specification. Particularly preferably, the change in accordance with the sequence sheet comprises a movement, in particular a speed of movement and/or a change in status, such as switching on and off, changes in intensity, focus, shape and/or color of at least one lighting object, in particular of the at least one determined lighting object. Even more preferably, the sequence sheet comprises a data packet that is directly transmittable to a lighting controller, in particular a lighting control system, through an output interface.

The method can take place using a real existing lighting object, in particular a lighting device at a performance area, in particular a stage, or virtually in a simulation. Furthermore, the method can be carried out using a virtual lighting object, in particular parameters in a control code. Further, the method is partially or fully automatable. In light show technology, it is common to first create complicated light shows in a simulation program and then feed these into the actually existing stage technology that is depicted by the simulation. Further, the sequence sheet can take into account possible restrictions existing as a result of the lighting object or at the user's request. In particular, it is conceivable that the sequence sheet first provides for the light source of the lighting object to be switched off before it moves to the end position. When the end position is reached, the light source of the lighting object is switched on again and the lighting features provided for in the sequence sheet are set.

It is comprehensible to a person skilled in the art that the previously described method comprises at least the five steps mentioned, which are repeatable individually or as a whole as often as desired. As described elsewhere, it is conceivable that the method also comprises further steps and/or that the steps described can be broken down into partial steps, substeps or subtasks.

By using the method according to the invention, the user's wish to change expressed in the voice command is implemented in a simple but effective way without the user having to use complicated programming language. In particular, the user can use everyday language and/or colloquial language. This enables simple and quick creation of light shows without prior training.

The term “language model” refers to a mathematical model that models the sequence of elements in a sequence of natural language and that is adapted in such a way that it captures and singles out at least one subtask in the natural language.

The term “subtask” refers to a request for change of a lighting state of at least one lighting feature of the lighting state expressed by the user, a selection assigned by the user of at least one lighting object or at least one group of lighting objects whose lighting state or lighting states are supposed to undergo a change and/or a direct or indirect aspect thereof and/or of an existing light show for at least one lighting object.

The term “lighting object” refers to an object with or without a direct physical counterpart within a lighting control system having at least one manipulable lighting feature, changing of the lighting feature being able to have a humanly perceptible static or dynamic change in the physical representation of the lighting control system. In particular, but by no means exclusively, a lighting object is a lighting device, a speed master, a cue, a preset, a sequence, a fixture, a temporal sequence and/or a lighting mood.

The term “lighting device” refers to a device that can generate light for illumination and/or for effect reasons for a light show and, in particular, that is controllable by a lighting control system.

The term “cue” refers to a container of data, in particular of lighting objects, which corresponds to an individual lighting mood or a look of the staging, a cue generally being preset and/or presettable.

The term “preset” refers to a container of data, in particular of lighting objects, a limited number of representations of determined lighting features that are used to create cues.

The term “sequence” refers to a list and/or a string of cues.

The term “type of lighting device” refers to the kind of lighting device. In particular, the type of lighting device can be a PAR spotlight, a blinder, a floodlight, a lens spotlight, a moving head, a scanner, a show laser, an LED spotlight, an area light, a horizontal light and/or a moving light. Further lighting devices and methods for controlling these are known to the person skilled in the art.

The term “lighting feature” refers to an individual feature of a lighting object or the value representing the individual feature and/or the setting range of the representing value. In particular, but by no means exclusively, a lighting feature is the status, color of light, hue, color temperature, brightness, zoom, focus, iris, shape, orientation, twist, position and/or speed.

The term “lighting state” refers to the set of all the lighting features of a lighting object.

The term “state of the lighting control system” refers to the set of lighting states of all the lighting objects in a lighting control system.

The term “obtain” refers to the collection of information and/or knowledge so that it is available to the machine learning model in a way that enables processing.

The term “machine learning model” refers to a program that is configured to recognize statistical correlations, patterns and/or structures between the information contained in the sets of training data without explicit specification in the programming and, based on this, to determine at least one output on the basis of information received as input.

The term “inference” refers to the deriving of at least one output by using the machine learning model created by the sets of training data.

The term “determine” or “determination” refers in particular to a selection of at least one lighting object, while at least one lighting feature of the at least one determined lighting object is supposed to be changed as specified by the user, a selection of at least one lighting feature, while the at least one lighting feature is supposed to be changed as specified by the user and/or a setting of at least one value of at least one determined lighting feature, which is supposed to correspond to the user's specification.

The term “agent” refers to an autonomously acting system that makes decisions by the input of information.

Advantageous further developments of the invention, which can be realized individually or in combination, are presented in the subclaims.

It is conceivable that the method according to step d. and/or according to step e. comprises a next step, step f., step f. comprising the following:
f. obtaining the at least one changed lighting feature and validating the at least one changed lighting feature.

In particular, during validation, there is preferably a check of whether the lighting feature has changed in the way provided for in accordance with the sequence sheet and in accordance with the subtask. By using the validation, it is possible to check whether performing steps b. to e. has led to the desired result. Particularly preferably, validation is carried out by an agent. Further preferably, the agent is a machine learning model trained for validation or a deterministic algorithm aimed at validation. For validation, in addition to the at least one changed lighting feature, the agent is preferably further provided with the at least one subtask, namely the at least one lighting feature, the determination of the at least one lighting object and/or the at least one lighting feature and/or the sequence sheet. The at least one lighting feature relates to the setting of the changed lighting feature before the change. Validation is more reliable as a result of the provision of more information. Even more preferably, all the lighting features changed in step e. are validated in step f. Most preferably, the state of the lighting system is obtained and validated. In particular, lighting features that have not been changed, but are supposed to undergo change according to the user's voice command, can be captured and taken into account in the validation as a result of the full capture. Additionally or alternatively, the validation can take place by means of questions and/or queries to the user.

In a further development, it is conceivable that step f. further comprises the following: modifying the subtask, the determination and/or the sequence sheet and repeating steps b., c., d., e. and/or f. if the validation has a negative result. If the changed lighting feature and/or the change of the changed lighting feature does not correspond to the specification of the subtask and/or the sequence sheet, a new sequence sheet is created by a modification in order to achieve the desired goal. It is obvious that the steps relating to the modification are repeated, depending on where the deviation occurred or where the modification is made. If the sequence sheet is modified, it is conceivable to not at all perform steps b. and c. again, or not fully. However, it is conceivable to perform step c. again in order to determine at least one further lighting object and/or at least one further lighting feature if necessary. It is preferably conceivable that the modification includes changing back the at least one changed lighting feature.

It is further conceivable that the voice command in step a. is verbal or written. A verbal voice command can be input by using an interface designed as a microphone. In particular, a written voice command can be entered by using an input interface, in particular a keyboard. It is conceivable that the voice command comprises both a verbal part and a written part, the parts being combined. Further, it is conceivable that the language model in step a. converts the verbal part into a written part, in particular a text. It is also conceivable that a verbal voice command is recorded elsewhere and is played back on site.

The term “verbal” refers to spoken language.

The term “written” refers to language that has been written down.

Moreover, it is conceivable that the sequence sheet comprises an executable control code for a lighting control system, in particular a lighting control panel, and that the change in step e. takes place by executing the control code. As a result, a direct and immediate change to the lighting technology at the event location can be achieved by the voice command using the method according to the invention. The control code preferably comprises at least one control command.

The term “lighting control system” refers to software, in particular software installed on a lighting control panel, with interfaces for controlling at least one real lighting device and interfaces to a human user, which allows the user to control the shape, focus, color, intensity and/or orientation of the emitted light of the lighting device, as far as technically possible and supported.

In a further development of the method, it is conceivable that, in step d., the sequence sheet is created by inference with the trained machine learning model involving input of the subtask. As a result, the subtask can be taken into account again at this stage of the method, which makes it possible to achieve better and more precise results. An intermediate validation by an agent or an agent system can also take place in order to prevent a faulty sequence sheet. The at least one determined lighting object, the at least one determined lighting feature and/or the at least one setting option continue to be input into the trained machine learning model in addition to the subtask.

The term “take into account” refers to the capturable provision of the information to be taken into account in such a way that the trained machine learning model and/or the language model can, but do not have to, recognize statistical relationships, patterns and/or structures therein, in particular in relation to the other inputs and/or information.

Furthermore, it is conceivable that in step b. the creation of the at least one subtask takes place taking context into account. This allows the integration of additional information when processing the voice command, which enables the user to have a largely more natural use of language. As a result, faulty execution of the sequence sheet is prevented and more precise results are achieved. Further, it is possible to extract information from a conversation of at least two users. Particularly preferably, the context is at least one previous voice command that was entered by the user before the current voice command. The user therefore does not have to generate a complete, comprehensible voice command each time. Preferably, at least 2, 3, 4, 5, 6, 7, 8, 9, 10, 11, 12, 13, 14, 15, 16, 17, 18, 19 or 20, in particular all, previous voice commands are taken into account.

Furthermore, it is conceivable that in step b. the creation of an at least one subtask, in step c. the determination of the at least one lighting object and the at least one lighting feature of the at least one determined lighting object by inference with the trained machine learning model and/or in step d. the creation of the sequence sheet by inference with the trained machine learning model take place taking into account at least one further factor. The further factor is preferably a piece of music, a location feature, an additional state of at least one additional device, a light show and/or a sketch. Taking into account the piece of music allows a light show that is better matched to the planned performance, thus simplifying creation of the light show for the user. In particular, a feature relating to the venue, in particular whether said venue is an indoor or outdoor area, is a location feature. Furthermore, a time feature can be taken into account, which enables conclusions about the brightness of the surroundings to be drawn. In particular, the additional device can represent equipment that is common in stage technology, such as a curtain, a screen and/or an effects device. It is also conceivable to create a video sequence for the screen by using an agent. The input of an existing light show, in particular as a control code, allows the light show to be adjusted to the circumstances and/or according to the user's individual wishes. In particular, the sketch can include a stage set and/or a stage construction.

It is also conceivable that in step c. at least one signal of at least one sensor and/or one transmitter is obtained, the determination of the at least one lighting object and the at least one lighting feature in step c. taking place by inference with the trained machine learning model and involving input of the at least one signal and/or in step d. the creation of the sequence sheet taking place by inference with the trained machine learning model and involving input of the at least one signal. Data that is external, but relevant to the light show, can be taken into account by the use of the sensor and/or the transmitter. In particular, the sensor and/or the transmitter can capture information about external data, such as the brightness of the surroundings, background noise from the surroundings and/or what is happening on the stage. In particular, the movements of people acting on the stage can be captured by means of the sensor. Particularly preferably, the sensor is a camera that captures the stage. Further preferably, the transmitter is part of a tracker. As a result, the stage show can be better adapted to the events taking place on the stage by means of voice commands. In addition to the signal, other factors mentioned elsewhere can or must be input and/or taken into account in step c. and/or step d.

In a further development of the invention, it is conceivable that the voice command comprises a control code in at least a first nomenclature, step b. and/or step c. comprising translation of the control code from the at least one first nomenclature into a second nomenclature. In the context of the invention, it has been recognized that a common problem in lighting control relates to the different nomenclatures of different manufacturers. Users are often especially well trained in at least one specific, first nomenclature and can therefore use it especially well. If a second nomenclature is used in the setup to which the method is applied, it is advantageous if the language model is trained to the effect that a translation of the at least one first nomenclature into the second nomenclature is made possible.

Furthermore, it is conceivable that the voice command takes place in any language or in multiple languages, the language model translating these into a standard language. As a result, it does not matter which language the user speaks.

It is further conceivable that the method in step b. comprises an evaluation of the voice command and/or of the at least one subtask and requesting of the input of a further voice command if the validation has a negative result. As a result, the voice command can be interpreted at an early stage as to whether all the information required to execute the voice command is known and/or unambiguous. If information is ambiguous and/or missing, it can simply be added by the user. Particularly advantageously, the first voice command and the voice command taking place in response to the request are taken into account. In other words, the first voice command represents a context described elsewhere as a previous voice command, which is taken into account by the language model. The request is preferably made in writing and/or verbally.

Furthermore, it is conceivable that the at least one setting option for the at least one lighting state is obtained by querying a database. Various information on the at least one lighting object, in particular on the at least one lighting device, is stored in the database, in particular as to what type of lighting device is concerned, what setting options are available for the lighting object, in what way they can be set, the position of the lighting device, a possible grouping with other lighting objects and/or a possible orientation of the lighting device. In this way, the type of setting option and its range can be determined quickly and easily.

It is assumed that the definitions and/or explanations of the above-named terms apply to all of the aspects described in the following in this description, unless otherwise stated. In particular, aspects of a computer system or a computer program product disclosed in connection with the method described above, possible embodiments of a computer system or a computer program product described in the following and aspects disclosed in the following in connection with a computer system or a computer program product that are features of a method are conceivable features of the method described hereinbefore.

Further according to the invention, a computer system is proposed, the computer system being configured to execute one of the methods described hereinbefore, and the computer system comprising at least one interface for receiving the voice command for performing step a., a computer readable storage medium for storing the language model and the trained machine learning model for performing steps b. to d. and at least one data processing device configured to perform steps b. and d.

The advantages disclosed in connection with the method can be achieved by this computer system. Preferably, the computer system comprises at least one sensor interface and/or at least one transmitter interface for receiving a signal emitted by a sensor and/or a transmitter. Further preferably, the interface is a microphone and/or a keyboard.

Furthermore, the computer system preferably comprises an output interface by means of which a sequence sheet and/or a control code can be transmitted to a lighting control system. Further preferably, the computer system comprises an output interface by means of which language, in particular written language or verbal language, can be output.

Particularly preferably, the output interface comprises a screen and/or a loudspeaker. The computer system can be a physical computer system on site, a computer system connected by a remote communication interface, in particular a cloud-based computer system and/or a hybrid form thereof.

Further according to the invention, a computer program product comprising sections of software code that are configured in such a way that one of the methods described hereinbefore is executable with at least one processor is proposed.

Further details, features and advantages of the invention result from the following description of the preferred embodiments in conjunction with the subclaims. In this context, the respective features can be realized individually or in combination with each other. The invention is not limited to the embodiments. The embodiments are shown schematically in the figures. Identical reference signs in the individual figures denote identical or functionally identical elements or elements corresponding to each other in terms of their function.

### BRIEF DESCRIPTION OF THE DRAWINGS

Specifically,

FIG. 1 shows a sequence chart of a method according to the invention and

FIG. 2 shows a computer system according to the invention.

### DETAILED DESCRIPTION

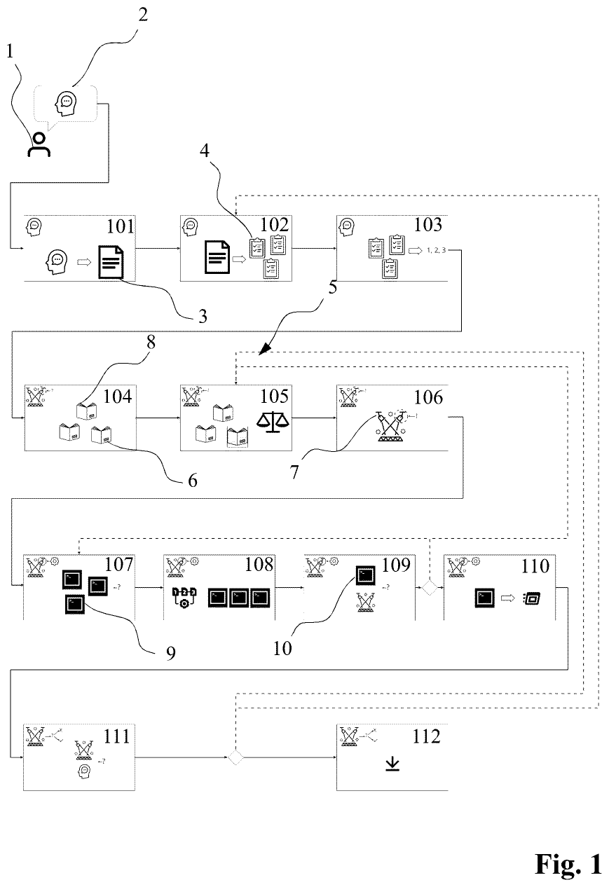

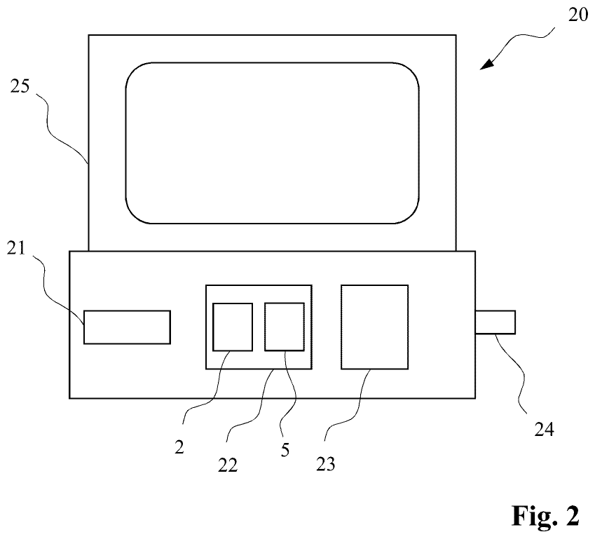

FIG. 1 shows a sequence chart of a method according to the invention. A user 1 speaks a voice command 2, which is recorded by a suitable interface 21 (see FIG. 2), for example a microphone. In a step a. 101, voice command 2 is fed to a language model 3. This is followed by a first partial step of a step b. 102 in which voice command 3 is broken down into three subtasks 4 by the language model 3 and, in a subsequent second partial step 103 of step b., the three subtasks 4 are arranged in an order. In the following first partial step 104 of a step c., at least one lighting feature 6 of three lighting objects 7 and their setting options 8 are obtained, for example by reading out a database and/or data stored in the lighting control system. The lighting features 6 obtained and the setting options 8 obtained are input into the trained machine learning model 5 along with subtasks 4 and are evaluated and weighted by said trained machine learning model 5 in the subsequent second partial step 105 of step c. This is followed by a third partial step 106 of step c. in which the trained machine learning model 5 determines one of the lighting objects 7 and at least one of the lighting features 6 of the determined lighting object 7 by inference on the basis of subtasks 4, lighting features 6 and setting options 8, same now being the determined lighting object 7 and the determined lighting feature 6.

In the subsequent first partial step 107 of a step d., the setting options 8 of the determined lighting object 7 are determined by the trained machine learning model 5, the trained machine learning model 5 determining and/or creating control commands 9 by inference.

Subsequently, in a second partial step 108 of step d., the determined control commands 9 are then brought into the correct order, and the commands are implemented in a sequence sheet 10, which is designed as a control code.

Afterwards, in a first partial step 109 of a step f., validation as to whether sequence sheet 10 is a sequence sheet 10 that can be executed on the lighting control system is carried out. If this is not the case, the (partial) steps, from the first partial step 107 of step d., are executed again. If the success intended by control commands 9 has occurred, sequence sheet 10 is executed in a step e. 110 and a comparison with subtasks 4 and/or voice command 2 uttered by user 1 takes place in the second substep 111 of step f. User 1 is asked for feedback. If the result does not correspond to subtasks 4, these are modified and the (partial) steps are executed again, from the first partial step 102 of step c. or from the second partial step 105 of step c., depending on where the deviation is localized. If the result corresponds to the goal defined in subtasks 4 and/or voice command 2 uttered by user 1, the procedure is terminated in a final step 112, involving saving of sequence sheet 10.

FIG. 2 shows a computer system 20 according to the invention. Computer system 20 comprises an interface 21 for receiving the voice command, a computer-readable storage medium 22 comprising trained machine learning model 5 and language model 3, and a data processing device 23. Furthermore, computer system 20 comprises an output interface 24 for transmitting a sequence sheet 10 and/or a control code to a lighting control panel and an output interface 25, by means of which feedback messages output as language can be output to the user.

The following examples only serve to illustrate the invention. They are not intended to limit the subject matter of the claims in any way.

### Example 1

In the following, a first example of the method according to the invention is explained by means of FIG. 1.

Voice command 2 uttered by user 1 is “Back of stage in Congo Blue.”

In the first partial step of a step b. 102, a subtask 4 is interpreted from voice command 2. Part of subtask 4 relates to the determination of lighting objects 7 designed as lighting devices from the “back of the stage” part of voice command 2. The trained machine learning model 5 can make a determination in the third partial step 106 of step c., in particular by statistical correlations through the group name of lighting objects 7, which, for example, are summarized under the group name “Backtruss”, on the basis of the knowledge of the positions of lighting objects 7, which can illuminate the back of the stage and/or on the basis of the knowledge of the degrees of freedom of lighting objects 7, which allow the back of the stage to be illuminated.

Suitable lighting features 6 must be determined for these lighting objects 7. This is a further part of subtask 4, which is derived from the “Congo Blue” part of voice command 2. The technical term “Congo Blue” must be interpreted first for this purpose, this task being able to be taken over by language model 3 in the second step b. 102 or by the trained machine learning model 5 in particular in the first partial step 104 of step c. This can take place in particular by searching a database, such as gel pools, color preset pools and/or color presets created by the user and/or by combining previously learned knowledge.

In the subsequent steps, a second partial step 105 of step c. up to a second partial step 108 of step d., the trained machine learning model 5 creates sequence sheet 10, taking into account setting options 8 of lighting features 6, such as in particular the color system used for lighting objects 7, RGB, HSB or CIE and/or the orientation setting, such as pan/tilt or XYZ coordinates, and the determination. The setting options 8 for brightness, zoom, focus, iris, shape, rotation and/or position should be taken into account in particular.

In order to achieve a uniform final result in the implementation in step e., the trained machine learning model 5 should take into account the temporal sequence of control commands 9 in such a way that the brightness is first reduced if necessary and is then increased according to the color setting, as lighting objects 7 would be of different brightness when a color change takes place, which can lead to a nonuniform image. Also, the brightness should only be increased when the position and/or orientation of lighting objects 7 provided for in sequence sheet 10 has been reached so that no unwanted light cones move across the stage. This means that the trained machine learning model 5 should automatically pause according to the position delta of the necessary movement of lighting objects 7 and the probable specific duration for this position delta after the position has been set, before the brightness is increased. In particular, both the at least one lighting feature 6 and all the previous voice commands 2 should be taken into account as context in order to be able to implement the desired intention without conflict and in a verifiable manner.

### Example 2

Voice command 2 uttered by user 1 is “Room in red, please.”

The steps are basically identical to those in the first example. It should be particularly emphasized here that trained machine learning model 5 and/or language model 3 must also be able to infer suitable lighting objects 7 designed as lighting devices for illuminating the room from the available data in the lighting controller without a precise indication of what the room is.

Furthermore, the trained machine learning model 5 should also be able to infer that the light from lighting objects 7 should be less focused if possible when illuminating such a large area. This is achieved by adjusting the zoom and/or the focus and thus the beam size, which makes it necessary to set further lighting features 6, taking into account the necessary order of control commands 9. Partial or complete repetition of steps c. and d. is advantageous at this point.

### Example 3

Voice command 2 uttered by user 1 is “Make the movements faster”.

The steps are basically identical to those in the first and second examples. To achieve the goal, however, an abstract lighting feature 6, such as the speed of moving lighting devices, must be changed to create sequence sheet 10. Lighting feature 6 of the speed usually has no direct physical equivalent as a directly controllable lighting feature 6 of a really existing lighting device. Accordingly, the abstract lighting feature 6 of the speed must be changed in an existing control code and/or the previously existing sequence sheet 10.

This can happen in different ways, depending on the lighting control system and its status. In particular, a sequence sheet 10 consisting of control commands 9, which increases the speed of movement effects for all the lighting scenes with these movement effects, can be created. Additionally and/or alternatively, it should be recognized that a so-called speed master, to which all these movements are assigned, exists. Under these circumstances, the trained machine learning model 5 should interpret and implement the user input to the effect that the speed of this speed master is increased.

### Example 4

Voice command 2 uttered by user 1 is “Move the thunderstorm scene to sunset”.

The steps are basically identical to those in the first, second and third examples. At this point, it is necessary to reveal what is meant by the input “thunderstorm and sunrise scene”. The trained machine learning model 5 should infer from the general knowledge of lighting control and the knowledge of the complete state of the lighting control system that it should move lighting objects 7 of the “cues” type, as the term “scene” is often used as a synonym for the term “cue”. The trained machine learning model 5 should then infer that “thunderstorm”, for example, refers to cue number five with the name, “thunder and lightning”, in the current cue list and that “sunrise” refers to cue number ten in this cue list, in which most of the lighting devices of the staging transition from yellow to red and are then faded out. The machine learning model 5 obtains this knowledge from the state of the lighting control system and uses inference to decide to generate a command that changes the order of lighting objects 7, cue number five and cue number ten, as part of the common lighting object 7 of a sequence, which arranges cue number five after cue number ten.

1. A method for changing at least one lighting state by voice command, said method comprising the following steps:
a. receiving a voice command and inputting the voice command into a language model
b. interpreting and breaking down the voice command into at least one subtask;
c. obtaining at least one lighting feature of at least one lighting object and at least one setting option of the at least one lighting feature, and determining at least one lighting object and at least one lighting feature of the at least one determined lighting object by inference with a trained machine learning model involving input of the at least one lighting feature the at least one setting option and the at least one subtask;
d. creating a sequence sheet by inference with the trained machine learning model involving input of the at least one determined lighting object, the at least one determined lighting feature or the at least one setting option; and
e. changing the at least one lighting state in accordance with the sequence sheet.

2. The method according to claim 1, and further comprising a step f performed after step d. after step e, said step f comprising:
f. obtaining the at least one changed lighting feature of the at least one changed lighting state and validating the at least one changed lighting feature.

3. The method according to claim 2, wherein step f further comprises
modifying the subtask, the determination and/or the sequence sheet and repeating steps b, c, d, e, or f responsive to the validating having a negative result.

4. The method according to claim 1, wherein the voice command in step a is present verbally or in writing.

5. The method according to claim 1, and
the sequence sheet comprising an executable control code for a lighting control system; and
the changing in step e being carried out by executing the control code.

6. The method according to claim 1, and
the sequence sheet being created by inference with the trained machine learning model involving input of the at least one subtask in step d.

7. The method according to claim 1, and
the at least one subtask being created taking context into account in step b.

8. The method according to claim 1, and
the creation of the at least one subtask in step b, the determination of the at least one lighting object and the at least one lighting feature of the at least one determined lighting object by inference with the trained machine learning model in step c, or the creation of the sequence sheet by inference with the trained machine learning model in step d being carried out based on at least one further factor.

9. The method according to claim 8, and
the further factor being a piece of music, a location feature, an additional state of at least one additional device, a light show, or a sketch.

10. The method according to claim 1, and
at least one signal of at least one sensor or at least one transmitter being obtained in step c and the determination of the at least one lighting object by inference with the trained machine learning model involving input of the at least one signal being carried out in step c, or
the creation of the sequence sheet by inference with the trained machine learning model involving input of the at least one signal being carried out in step d.

11. The method according to claim 1, and
the voice command being a control code in at least one first nomenclature and step b or step c comprising translation of the control code from the at least one first nomenclature into a second nomenclature.

12. The method according to claim 1, and
the method in step b comprising an evaluation of the voice command or of the at least one subtask and a request to input a further voice command if the validating has a negative result.

13. The method according to claim 1, and
the at least one setting option of the at least one lighting state being obtained by querying a database.

14. A computer system configured to execute the method according to claim 1, said computer system comprising:
at least one interface receiving the voice command for performing step a;
a computer-readable storage medium storing the language model and the trained machine learning model performing steps b to d; and
at least one data processing device configured to perform step b and step d.

15. A computer program product, comprising sections of software code configured so as to cause at least one processor to perform the method according to claim 1.

16. The method according to claim 1, wherein step b further comprises sorting the at least one subtask.
